(19) United States
(12) Patent Application Publication
(10) Pub. No.: US 2004/0112319 A1
(43) Pub. Date: Jun. 17, 2004

(54) Meshing method for the starter pinion in the ring gear of an internal combustion engine and starter motor for carrying out the method

(76) Inventor: Miloslav Hnilica, Kromeriz (CZ)

Correspondence Address: NOTARO AND MICHALOS, 100 DUTCH HILL ROAD, SUITE 110, ORANGEBURG, NY, 10962-2100, US

(21) Appl. No.: 10/474,550

(22) PCT Filed: Nov. 19, 2001
(86) PCT No.: PCT/CZ01/00066

(30) Foreign Application Priority Data
Apr. 10, 2001 (CZ) PV 2001-1282

(51) Int. Cl. F02N 11/00

(52) U.S. Cl. 123/179.25; 74/7 A; 290/48

(57) ABSTRACT

A starter for an internal combustion engine produces less noise and has a longer life and includes a transmission element for actuating an electric motor. The transmission element has two independently coaxially seated components—a stop pin and an engaging bar. The engaging bar is positioned between a pinion of the motor and the stop pin. The stop pin is seated in an internal shoulder in a cavity of the armature shaft of the electric motor and through the shoulder of a fixed core. A narrow portion of the stop pin is seated in an engaging spring positioned in the cavity of a mobile core of a disengaging electromagnet. The stop pin bears with a second front surface against a washer secured in the mobile core, where the length of the mobile core cavity is greater than the length of the narrow part of the stop pin by a predetermined distance c.

### TECHNICAL FILD

This invention relates—the starter of internal combustion engines, above all car's internal combustion engine starter with a disengaging pinion, electromagnetically disengaged into the engagement with gear rim of the internal combustion engine.

### BACKGROUND ART

Internal combustion engine starters are designed so, that the disengaging pinion is disengaged into the engagement with gear rim of the internal combustion engine through the action of magnet core onto the pinion or through, frequently, two-armed lever, and the magnet is situated outside of electric motor axis with the pinion so, that their axes are parallel.

A solution is also well known, when disengaging magnet is situated in pinion axis of the starter but electric motor is situated in the position being parallel to those. At these starter realizations, at the design solution of electric motor is applied an internal gearing with ferrite permanent magnets working in high speed reducing eletric motor speed onto the necessary value of pinion speed at the engagement of pinion teeth into gear rim teeth. This gearing is carried in electric motor axis in the case of a planet solution or in pinion axis, if this isn't situated in electric motor axis.

From U.S. Pat. No. 5,081,874 is known a design solution of the starter, at which the pinion is engaged into engagement with gear rim of internal combustion engine through transmission element formed by one disengaging bar inserted in armature shaft cavity, supposing that this disengaging bar is forming with mobile core of disengaging electromagnet a dynamical unit. If, at pinion disengagement, pinion teeth are striking rim teeth of internal combustion engine, the motion of mobile core, and with this coupled disengaging bars will not stop, the shooting spring inserted into the mobile core is all the time compressed till the moment, when pinion tooth will engage into the space of gear rim tooth of internal combustion engine. Because full current is already brought in into the armature, and the pinion is rotating in its full output, the pinion will be intensively shot into the gear rim of internal combustion engine, which is connected with strokes, and with a great wear of pinion teeth and of gear rim teeth of internal combustion engine. Other great disadvantage of this US patent is the necessity to secure the ball inserted between pinion end and engaging bar. This ball is inserted here to inhibit the transmission of pinion rotative motion onto mobile core at spring compression, when into the armature is already brought a full output. Ball securing between pinion end and disengaging bar is very questionable, because in consequence of great dynamical strokes originating in pinion engagement into gear rim of internal combustion engine, the ball can easily drop out.

Common disadvantage of all these well known starter solutions is that to insert pinion teeth into flywheel gear rim teeth, at the striking of pinion tooth into flywheel gear rim tooth of internal combustion engine, is applied so called shooting spring, which will violently shoot the pinion at full torsional moment of the armature into flywheel gear rim teeth, which is in conjunction with strokes and a great wear of pinion teeth and of flywheel gear rim teeth.

Another disadvantage of all these well known and above described solutions is a quite great complexity, and relative corresponding lower working reliability. Another disadvantage of all these solutions is the assembly limited in position onto internal combustion engine. A disadvantage of starters with gear is also quite high noise at the start through the influence of the function at high speed.

### DISCLOSURE OF THE INVENTION

The applied for invention is aiming to offer an improved starter for internal combustion engines consisting of stator of electric motor with permanent magnets from electric motor armature, from front cover and from rear cover, in which is situated a disengaging electromagnet with mobile core, and contacts for the connection to the bridge, supposing that from front cover is getting out the pinion, which is slidingly situated in the cavity of electric motor armature shaft, and which is operated by a transmission element through mobile core of disengaging electromagnet. Invention principle is consisting in the fact that the transmission element is consisting of two independently co-axially situated parts, from which the first part is formed by an engaging bar, and the second part is formed by a stop pin. The engaging bar is situated between pinion end and stop pin, and is led through internal shoulder in the cavity of armature shaft of electric motor to be placed in fixed core. This engaging bar isn't coupled in the motion with mobile core of the disengaging electromagnet and of the pinion. The stop pin is situated with its narrow part placed in the engaging spring adapted in the cavity of mobile core of disengaging electromagnet, and with its first side this is beared against the first front surface of the step pin, and with its second part against the cavity bottom of mobile core of disengaging electromagnet. Step pin with its second front surface is beared against the washer secured in mobile core of disengaging electromagnet. In case that, at pinion engagement into gear rim of internal combustion engine, pinion teeth will be bumped into gear rim teeth of internal combustion engine, the engaging bar is acting against the motion of stop pin, ending stop surface of which will bear against the cavity bottom of mobile core, and in this way it will stop its motion, which will cause that contacts with the bridge can't switch before pinion engagement into gear rim of internal combustion engine and in this way it will energize full torsional moment of the armature, and it will rotate the pinion with its full output. This is secured so that cavity length of mobile core is greater by pre-set distance than is the length of narrow part of the stop pin. Between fixed core and mobile core of disengaging electromagnet is situated a return spring.

To prevent from a strong bearing of mobile core onto bearing surface of rear shield of the rear cover at back motion of mobile core of the disengaging electromagnet, the mobile core is bearing through the insulation bushing, and contact spring against the internal surface of the shield of rear cover, and between the washer of the mobile core, and the internal surface of the cover is created a space supposing that this space is identical as the space between insulation bushing and insulating washer of the bridge.

An advantageous realization of the bar is that this is made from non-magnetic material, with the advantage as moulding from plastic. To create a reduced torsional moment of the armature at pinion engagement before the switching of contacts with bridge is advantageous to create stator magnets from material NdFeB.

The main advantage of the invention is consisting in the fact that at the striking of pinion tooth onto gear rim tooth of internal combustion engine, the motion of mobile core will be stopped, and this will not compress the spring inserted in the mobile core, which will cause that contacts with bridge will not be switched instantaneously, and in this way will be achieved the full torsional moment of the armature, and the pinion will be rotated to full output before its engagement into gear rim of internal combustion engine. Only at the moment, when pinion teeth will rotate on gear rim teeth of internal combustion engine, and the pinion is engaged into gear rim of internal combustion engine, contacts with bridge will be switched, and the pinion will rotate in full output. The pinion is carefully engaged into gear rim of internal combustion engine, which is manifested by a low noise, and by a higher life of pinion, and gear rim teeth of internal combustion engine. In this way is reduced also the noise at strokes of pinion teeth onto gear rim teeth of internal combustion engine. At the utilization of freely seated bar for the transfer of axial force from the mobile core of disengaging electromagnet onto the pinion is also simplified the whole design of engaging mechanism.

### BRIEF DESCRIPTION OF THE DRAWINGS

The presented invention will be explicated in detail according to the following technical description, which is elaborated according to enclosed drawings, on which

FIG. 1 represents section through the starter,

FIG. 2 represents section through the starter according to FIG. 1 with the seating of disengaging electromagnet, disengaging bar, and pinion end part.

### BEST MODE FOR CARRYING OUT THE INVENTION

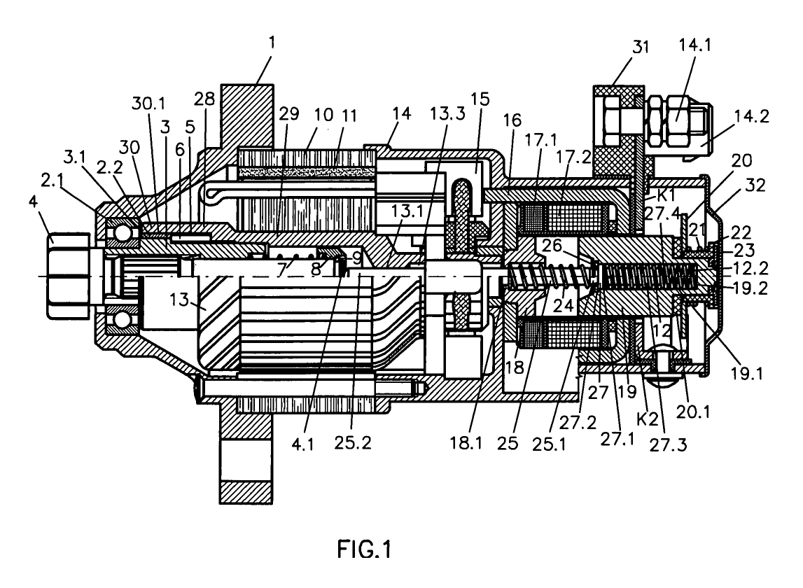

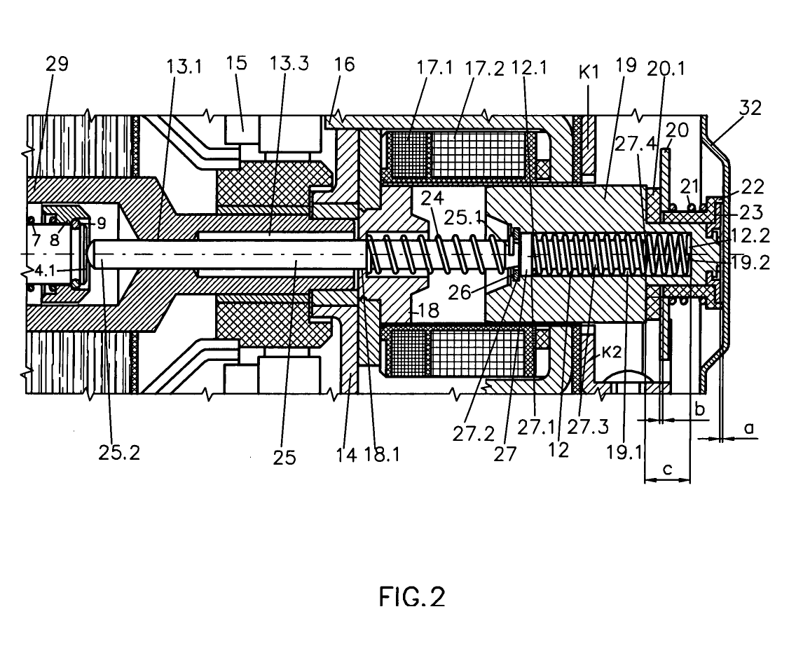

The starter according to FIGS. 1 and 2 is consisting of electric motor producing turning moment, of stator 10 of electric motor containing permanent magnets 11 from material with high remanence, and coercivity, e.g. NdFeB. The starter is further consisting of front cover 1, and of rear cover 14. In rear cover 14 is seated disengaging electromagnet 16 containing fixed core 18, and mobile core 19, retaining winding 17.1, and retracting winding 17.2. In rear cover are further embedded contacts K1 and K2 for the connection with the bridge 20, and brush supports 15. From front cover 1 is projecting the pinion 4, which is slidingly seated in the cavity 13.3 of the shaft 29 of the armature 13 of electric motor. The pinion 4 is on its end 4.1 equipped by a return spring 7, embedded between stop ring 8, and engagement bushing 3 of overrunning clutch 28. The overrunning clutch 28 is seated in the end of the shaft 29 of the armature 13 of electric motor, and this contains rollers 5, and springs 6. The stop ring 8 is secured by a retaining ring 9, secured in the end 4.1 of the pinion 4. The prolongated end 30 of the overrunning clutch 28 is with its internal cylindrical diameter 30.1 seated through the bearing 2.2 on external prolongated part 3.1 of engagement bushing 3. The end of engagement bushing 3 is led through a ball bearing 2.1 embedded in front cover 1. Pinion 4, armature 13 of electric motor, and disengaging electromagnet 16 are arranged in their mutual position in one axis. Pinion 4 is actuated, in the engagement with not represented flywheel gear rim of internal combustion engine, through a transmission element consisting of two independently seated parts, from which the first part is engaging bar 25, and the second part is stop pin 27. The engaging bar 25 is embedded between the end 4.1 of pinion 4, and stop pin 27, and on the side of the pinion 4 this is led through internal shoulder 13.1 in the cavity 13.3 of the shaft 29 of the armature 13 of electric motor, and on the side of disengaging electromagnet 16 this is led through the shoulder 18.1 in fixed core 18. This engaging bar 25 isn't connected in the motion with mobile core 19 of disengaging electromagnet 16, and also of pinion 4. The engaging bar 25 is made from non-magnetic material, with an advantage of a plastic moulding. Stop pin 27 is embedded with its narrow part 27.3 in engaging spring 12 adapted in the cavity 19.1 of mobile core 19 of disengaging electromagnet 16 the engaging spring 12 with its first side 12.1, is bearing against the first front surface 27.1 of stop pin 27, and with its second side 12.2 against the bottom 19.2 of the cavity 19.1 of mobile core 19 of disengaging electromagnet 16. Stop pin 27, with its second front surface 27.2, is bearing against the washer 26 secured in mobile core 19. Between the end stop surface 27.4 of narrow part 27.3 of the stop pin 27, and the bottom 19.2 of the cavity 19.1 of mobile core 19 of disengaging electromagnet 16 is pre-set up a free distance c. This free distance c is set up in the way to prevent the switching of the bridge 20 with contacts K1 and K2 before the engagement of the pinion 4 into the gear rim of internal combustion engine. The free distance c is calculated as difference between the length of cavity 19.1 of mobile core 19, and the length of narrow part 27.3 of the stop pin 27. The length of cavity 19.1 of mobile core 19 is measured between front surface 27.1 of stop pin 27, and the bottom 19.2 of mobile core 19.

The mobile core 19 of disengaging electromagnet 16 is bearing through insulation bushing 22, and contact spring 21 against the internal surface of the cover 32, which is closing the rear cover 14. Between the insulation bushing 22 of mobile core 19 of disengaging electromagnet 16, and the internal surface of the cover 32 is a space a, which is so great as the space b between the insulation bushing 22, and the insulation washer 20.1 of the bridge 20. These spaces a and b are preventing from a strong bearing of the mobile core 19 of disengaging electromagnet 16 against the surface of the shield 32 of rear cover 14 at back motion of the pinion 4 from the gear rim of internal combustion engine. In rear part of the rear cover 14, in the connection with the contact K1 of disengaging electromagnet 16 is embedded the terminal board 31 with an outlet 14.1 made with the screw on accumulator battery, and the outlet 14.2 of retaining winding 17.1 and retracting winding 17.2 on start push button or switching box with start position.

After stream feeding through the retracting winding 17.2 into the armature 13 of electric motor, and its rotation through reduced moment from permanent magnets 11 with high remanence, the rotative motion is transferred through overrunning clutch 28, and through engagement bushing 3 onto the pinion 4, which is slidingly connected with the engagement bushing 3. At the same time is beginning an axial motion of the mobile core 19 with the engaging spring 12, which is pressing the stop pin 27 through the washer 26 to the first end 25.1 of the engaging bar 25. The second end 25.2 of the engaging bar 25 is pressing with its rounded end to the end 4.1 of the pinion 4. In the case, that the tooth of the pinion 4 is oriented into tooth space of non presented gear rim of internal combustion engine, then the mobile core 19 with the engaging bar 25 is continuing its motion, and the pinion 4 is engaged into the engagement with gear rim of internal combustion engine through the pression of the engaging bar 25. At this moment will be switched contacts K1 and K2 with the bridge 20, and also the interconnection of stream circuit of electric motor of the starter, and the rotation of the pinion 4 through a full torsional moment. In this way is the starter put into operation. At the back motion of mobile core 19, when the pinion 4 is disengaged from the gear rim of internal combustion engine, the insulation bushing 22 will bear against the internal surface of the cover 32, the mobile core 19 is further continuing the motion, and at the same time the contact spring 21 is compressed up to the phase, when the securing washer 23 overcomes the distance a, if the case may be b, and it will also bear against the internal surface of the cover 32. In this way, the stroke of the mobile core 19 is damped down at the back motion.

In the case, that within the disengagement of the pinion 4, its tooth will impact the tooth of the non presented gear rim of internal combustion engine, the engaging spring 12 is damping the inpact of the pinion 4 onto gear rim of internal combustion engine, and freely seaded engaging bar 25 is acting against the motion of the stop pin 27, the end stop surface 27.4 of which will bear against the bottom 19.2 of the cavity 19.1 of the mobile core 19. At this moment, the axial motion ot the pinion 4, and also of the stop pin 27 is stopped, and at the same time is stopped also the compression of the engaging spring 12. The difference between the length of the cavity 19.1 of the mobile core 19, and the narrow part 27.3 of the stop pin 27 (free distance c) will prevent from the switching of contacts K1 and K2 with the bridge 20 before the engagement of the pinion 4 into the gear rim of internal combustion engine, and in this way the pinion 4 will be rotated in full torsional moment. At this moment, that is at the moment of the stroke of its teeth onto teeth of gear rim of internal combustion engine, the pinion 4 is rotated at reduced torsional moment of the armature 10 of electric motor. As soon as teeth of the pinion 4 will rorate on gear rim of internal combustion engine into the position, in which is facilitated the engagement of the pinion 4 into gear rim of internal combustion engine, the engaging spring 12 through stop pin 27, and the engaging bar 25 will carefully engage the pinion 4 into teeth of gear rim of internal combustion engine supposing, that afterwards contacts K1 and K2 with the bridge 20 will be interconnected, and in this way will be made the interconnection of stream circuit of electric motor of the starter, and the rotation of the pinion 4 in full torsional output. In this way is the starter put into operation.

At the back motion of the mobile core 19, when the pinion 4 is disengaged from the gear rim of internal combustion engine, the insulation bushing 22 will bear against the internal surface of the cover 32, the mobile core 19 is further continuing its motion, at the same time the contact spring 21 is compressed up to the phase, when securing washer 23 overcomes the distance a, if the case may be b, and also it will bear against the internal surface of the cover 32. In this way the stroke of the mobile core 19 will be attenuated at the back motion.

1. The starter of internal combustion engines consisting of the stator 10 of electric motor with permanent magnets 11, of armature 13 of electric motor, of front cover 1, and of rear cover 14, in which is seated disengaging electromagnet 16 with mobile core 19 and with contacts K1,K2 for the connection with the bridge 20, supposing that from the front cover 1 is projecting the pinion 4, which is slidingly seated in the cavity 13.3 of the shaft 29 of the armature 13 of electric motor, and which is actuated by a transmission element through the mobile core 19 of disengaging electromagnet 16, characterized by the fact that the transmission element is consisting of two independently coaxially seated parts, from which the first part is engaging bar 25, and the second part is stop pin 27, supposing that the engaging bar 25 is positioned between the end 4.1 of the pinion 4, and the stop pin 27, and this is led through the internal shoulder 13.1 in the cavity 13.3 of the shaft 29 of the armature 13 of electric motor, and through the shoulder 18.1 in fixed core 18, and the stop pin 27 is seated with its narrow part 27.3 in the engaging spring 12 adapted in the cavity 19.1 of mobile core 19 of disengaging electromagnet 16, and is bearing with its first side 12.1 against the first front surface 27.1 of the stop pin 27, and with its second side 12.2 against the bottom 19.2 of the cavity 19.1 of mobile core 19 of disengaging electromagnet 16, supposing that the stop pin 27 is bearing with its second front surface 27.2 against the washer 26 secured in the mobile core 19, supposing that the length of the cavity 19.1 of mobile core 19 is greater by preset distance c, than is the length of the narrow part 27.3 of the stop pin 27, and between fixed core 18 and mobile core 19 of disengaging electromagnet 16 is situated a return spring 24.

2. Starter according to claim 1
characterized by the fact
that the mobile core 19 of disengaging electromagnet 16 is bearing through the insulation bushing 22, and the contact spring 21 against the internal surface of the shield 32 of the rear cover 14, supposing that between the insulation bushing 22 of the mobile core 19, and the internal surface of the shield 32 is adapted a space a identical as the space b between the insulation bushing 22, and the insulation washer 20.1 of the bridge 20.

3. Starter according to claims 1 and 2
characteriz d by the fact
that in the outlet 14.1 of the rear cover 14, in the interconnection with the contact K1 of disengaging electromagnet 16, is situated a terminal board 31.

4. Starter according to claims 1 up to 3
characterized by the fact
that the engaging bar 25 is made from non-magnetic material.

5. Starter according to claims 1 up to 4
characterized by the fact
that the engaging bar 25 is made from plastic material.

6. Starter according to claims 1 up to 5
characterized by the fact
that permanent magnets of the stator 10 are made from material NdFeB.
